(19) United States
(12) Patent Application Publication
(10) Pub. No.: US 2026/0208986 A1
(43) Pub. Date: Jul. 23, 2026

(54) UNLOADING SYSTEM

(71) Applicant: ANGLO AMERICAN TECHNICAL & SUSTAINABILITY SERVICES LTD, London (GB)

(72) Inventors: Luke Michael SMITH, London (GB); Nigel Mark SOLEY, Brisbane (AU)

(21) Appl. No.: 19/138,572

(22) PCT Filed: Dec. 13, 2023
(86) PCT No.: PCT/IB2023/062595

§ 371 Date: Jun. 12, 2025

(30) Foreign Application Priority Data
Dec. 14, 2022 (GB) 2218841.1

(51) Int. Cl. B65G 67/56; B65G 67/54

(52) U.S. Cl. CPC B65G 67/56; B65G 67/54

(57) ABSTRACT

A low-weight tipper unit or unloading system (10) used in the course of unloading raw materials (12) from haul vehicles (16) typically used in mining and construction operations. The unloading system (10) comprises a support surface (18) configured for operatively receiving the vehicle (16). The support surface (16) is fixed to a base structure (20) and pivotable between a first position and a second position. A retaining arrangement (24) is provided for retaining the vehicle (16) relative to the support surface (18) in use. An energy harnessing arrangement (44) harnesses energy when the support surface (18) is pivoted under load to the second position.

### BACKGROUND TO THE INVENTION

This invention relates to the field of raw material handling. More particularly, the present invention relates to a low-weight tipper unit or system used in the course of unloading haul vehicles used in the transport of raw material, typically used in mining and construction operations.

Increased focus on energy efficiency and environmental impact, also in the mining and construction industries, calls for efficiency improvements in excavation and raw materials handling processes. To this end, focus is shifting towards smaller and more efficient haul trucks (smaller in this case facilitates implementation of more energy efficient technologies, greater autonomy and, in some cases, renewable energy). Furthermore, a focus is also placed on improvements in terms of energy efficiency of surrounding systems and processes to result in a holistic focus on energy expenditure and efficiency.

One aspect that contributes significantly to the weight of a haul truck, is onboard mechanisms used for unloading the tray of the haul truck. For example, typical tipper haul trucks include large and heavy hydraulic actuator arrangements and associated systems, which are used to lift the tray during tipping. Furthermore, to withstand the forces associated with lifting and tipping the tray, both the tray and the chassis of the haul truck need to be reinforced and strengthened, which again adds significantly to the overall weight of the haul truck. Also, moving components associated with the tipping of a tray of a haul vehicle (such as the hydraulic systems, pivots and the like) are known to wear relatively quickly and could lead to stoppages and maintenance down-time, negatively impacting availability of the equipment, and increasing maintenance and operational costs associated with the material handling processes.

The use of side-tipping support surfaces to unload haul vehicles (including trains) is known. However, these systems are known to cause abnormally high lateral loading and stress to the tyres and structural components, such as the chassis, carrier body and the like, of the haul vehicle. Furthermore, energy expended when side-tipping these haul vehicles is relatively high, particularly since the whole haul vehicle needs to be tipped (a large weight in addition to the weight of the payload therefore needs to be tipped). These systems therefore do not necessarily result in an overall reduction in energy expenditure.

It is believed that a reduction in the weight of the haul vehicle by removal of equipment and structures provided for facilitating tipping of the haul carrier could have a profound impact on the overall energy expenditure of raw material handling processes of a mining or construction operation, provided energy efficient unloading of the haul vehicles could be provided for.

Also, a reducing in the overall weight of the haul vehicle could bring same into an order more suitable for use of alternative, environmentally efficient and/or renewable energy resources.

It is accordingly an object of the invention to provide an unloading system and a method of unloading a vehicle that will, at least partially, address the above disadvantages or facilitate the above potential improvements.

It is also an object of the invention to provide an unloading system and a method of unloading a vehicle which will be a useful alternative to existing systems and methods.

### SUMMARY OF THE INVENTION

In accordance with a first aspect of the invention there is provided an unloading system for a haul vehicle, the system comprising:
a support surface configured for operatively receiving the vehicle, which support surface is fixed to a base structure and pivotable between a first position and a second position;
a retaining arrangement for operatively releasably retaining the vehicle relative to the support surface;
an energy harnessing arrangement, configured to harness energy when the support surface is pivoted under load to the second position.

The first position may be a loading position in which the support surface is configured in a substantially horizontal orientation to allow loading the vehicle onto the support surface. The second position may be a tipped position. In some cases, the support surface may be tipped in a travel direction of the vehicle.

The base structure comprises a first level, and the support surface may be fitted to the base structure by means of a pivot. The support surface may be accessible from the first level by the vehicle when the support surface is in the first position.

In some cases, the base structure may be a fixed structure, whereas in other cases, the base structure is a mobile base which includes means for displacing the base relative to a ground surface.

The retaining arrangement may take the form of a hook formation for operatively latching onto a catch formation associated with the vehicle. Alternatively, the retaining arrangement may take the form of a catch formation for operatively latching onto a hook formation associated with the vehicle.

The retaining arrangement may furthermore (in addition or alternatively) include a receiving formation for operatively receiving a first set of wheels of the vehicle and retaining same relative to the support surface.

The system may further include a first locking arrangement provided for releasably locking the support surface in the first position, to facilitate loading the vehicle onto the support surface without moving to the second position.

The system may also comprise an actuator (typically in the form of a hydraulic ram arrangement) operatively to return the support surface to the first position.

The hydraulic ram may form part of the energy harnessing arrangement. The hydraulic ram may be provided in fluid flow communication with a hydraulic fluid circuit which includes an accumulator. The hydraulic fluid circuit may include a first flow controller with which the hydraulic fluid circuit is configurable in:
a first configuration in which fluid flow to or from the hydraulic ram is inhibited to lock the support surface in the first or second positions;
a second configuration in which flow of hydraulic fluid from the hydraulic ram into the accumulator is facilitated, thereby allowing the accumulator to be charged with pressurised hydraulic fluid thereby harnessing potential energy; and
a third configuration in which flow of hydraulic fluid from the accumulator to the hydraulic ram is facilitated, thereby allowing the hydraulic ram to actuate the support surface to the first position.

The hydraulic circuit may furthermore include a pump to provide pressurised hydraulic fluid to the hydraulic ram, to supplement hydraulic fluid provided to the hydraulic ram by the accumulator.

The support surface may be biased towards the first position and may be associated with a counterweight which biases same towards the first position. The counterweight may be fixed directly to a first side of the support surface. Alternatively, the counterweight may be connected to the support surface by means of a pulley system.

The system may be configured such that a predetermined load received on the support surface may be required to overcome the bias, allowing the support surface to pivot towards the second position/ The configuration may furthermore be such that the vehicle, when loaded, exceeds the predetermined load.

The system may furthermore include a second locking arrangement provided for releasably locking the support surface in the second position.

The system may typically be arranged proximate a raw material dump location which is situated at a level below the first level.

The unloading system may include a ramp from the ground surface to the first level which may allow the haul vehicle to be propelled onto the support surface.

The means for displacing the base relative to the support surface may comprise wheels or tracks. Some of the wheels or tracks may be driven. Alternatively, the base may comprise a tow connection point.

In accordance with a second aspect of the invention there is provided a method of unloading raw material from a haul vehicle, the method comprising the steps of:
i) providing a system according to the first aspect of the invention.
ii) receiving the vehicle on a support surface of the system which is provided in a first position;
iii) retaining the vehicle relative to the support surface;
iv) allowing the support surface to pivot towards a second position;
v) harnessing energy by means of an energy harnessing arrangement while the support surface pivots towards the second position.

The method may comprise further steps of:
vi) allowing the raw material to be unloaded from the haul vehicle;
vii) utilising at least some of the harnessed energy to return the support surface to the first position;
viii) releasing the vehicle from the support surface; and
ix) removing the vehicle from the support surface.

Step v) may comprise configuring a hydraulic ram of the system to pump hydraulic fluid into a hydraulic accumulator.

Step vii) may comprise allowing at least some hydraulic fluid stored within the hydraulic accumulator to flow towards the hydraulic ram.

The method may include supplementing fluid flowing towards the hydraulic ram utilising a hydraulic pump.

Step vi) may include a sub-step of configuring a lock arrangement of the system to lock the support surface in the second position. Step vii) may be preceded by the sub-step of configuring the lock arrangement to allow the support surface to be displaced from the second position.

Step ii) may be preceded by a sub-step of configuring a lock arrangement of the system to lock the support surface in the first position. Step iv) may be preceded by the sub-step of configuring the lock arrangement to allow the support surface to be displaced from the first position.

Step iv) may comprise allowing the support surface to pivot towards the second position under a load caused by the vehicle being received on the support surface.

In accordance with a further aspect of the invention there is provided an unloading system for a haul vehicle, the system comprising:
a support surface configured for operatively receiving the vehicle, which support surface is fixed to a base structure and pivotable between a first position and a second position;
a brace unit configured for operatively engaging a structural part of the vehicle thereby retaining the vehicle relative to the support surface when the support surface is pivoted to the second position.

The brace unit may be configurable between a disengaged configuration in which the brace unit is operatively spaced from a structural part of the haul vehicle, and an engaged configuration, in which the brace unit operatively engages the structural part of the haul vehicle. The brace unit may be pivotably fixed relative to the support surface and may be lockable in the engaged configuration. The brace unit may comprise one or more contact shoes which may be provided for operatively exerting a distributed load on the structural part of the vehicle. The contact shoes may contact the structural part of the haul vehicle, which may be on a front or side of the vehicle. Furthermore, the brace unit may comprise a rim portion which may be shaped commensurate with the structural part of the haul vehicle. The rim portion may define an opening through which material may operatively be unloaded from the haul vehicle. The opening may be substantially U-shaped.

The base structure may be a mobile base which may include means for displacing the base relative to a ground surface.

The system may include a ramp from the ground surface to the support surface, allowing the haul vehicle to be propelled onto the support surface.

The means for displacing the base relative to the ground surface may comprise wheels or tracks. Some of the wheels or tracks may be driven. Alternatively, the base may comprise a tow connection point.

The system may comprise a pivoting mechanism in the form of one or more hydraulic rams provided for pivoting the support surface between the first position and second position.

### BRIEF DESCRIPTION OF THE DRAWINGS

The invention will now be described in more detail, by way of example only, with reference to the accompanying drawings in which:

FIG. 1 shows a schematic side view of an unloading system in accordance with one aspect of the invention, before a haul vehicle is received;

FIG. 2 shows a schematic side view of the unloading system of FIG. 1, after the haul vehicle has been received but before same has been unloaded, with a support surface of the unloading system in a first position;

FIG. 3 shows a schematic side view of the unloading system of FIG. 1, in which the haul vehicle is tipped forwards to facilitate unloading thereof, and wherein the support surface is in a second position;

FIG. 4 shows a perspective view of an unloading system in accordance with an alternative example embodiment of the invention;

FIG. 5 shows a side view of the unloading system of FIG. 4;

FIG. 6 shows a perspective view of the unloading system of FIG. 4 with a haul vehicle received on a support surface, in use;

FIG. 7 shows a front view of the unloading system of FIG. 4 with the haul vehicle received on the support surface, in use, the support surface configured in a first position;

FIG. 8 shows a front view of the unloading system of FIG. 4 with the haul vehicle received on the support surface, in use, the support surface configured in a second or unloading position; and

FIG. 9 shows a system comprising two of the unloading systems of FIG. 4 in side-by-side fashion.

### DESCRIPTION OF THE ILLUSTRATED EMBODIMENTS

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted”, “connected”, “engaged” and variations thereof are used broadly and encompass both direct and indirect mountings, connections, supports, and couplings and are thus intended to include direct connections between two members without any other members interposed therebetween and indirect connections between members in which one or more other members are interposed therebetween. Further, “connected” and “engaged” are not restricted to physical or mechanical connections or couplings. Additionally, the words “lower”, “upper”, “upward”, “down” and “downward” designate directions in the drawings to which reference is made. The terminology includes the words specifically mentioned above, derivatives thereof, and words or similar import. It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Referring to the drawings, in which like numerals indicate like features, a non-limiting example of an unloading system (or simply “system”) in accordance with the invention is generally indicated by reference numeral 10.

The system 10 is used to unload a load of raw material 12 from a carrier body 14 of a haul vehicle 16. It will be appreciated that the present disclosure is not limited by the type of vehicle 16 used. However, in general terms, the system 10 and vehicle 16 are configured to enable interaction as discussed more fully below. Furthermore, generally, though not exclusively, the vehicle 16 has a fixed carrier body and does not have on-board means for tipping the carrier body or unloading the load of raw material 12 therefrom. The carrier body 14, is open-ended towards a top thereof. The use of the system 10 therefore facilitates such unloading in the absence of such hardware. It will therefore be appreciated that the use of the system 10 specifically enables omission of such hardware, which results in a lower tare weight of the vehicle than that of comparable (in size or carrying capacity) haul vehicles including such hardware.

The system 10 comprises a support surface 18. The support surface is schematically shown in a simplified configuration in the figures. However, it will be appreciated that the support surface 18 and other structural components of the system 10 have structural integrity fit for the purposes discussed below.

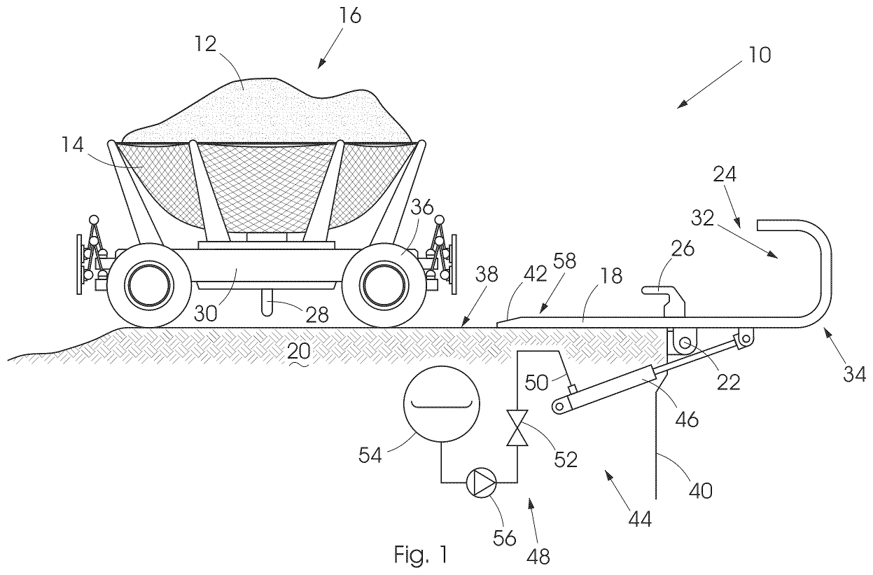

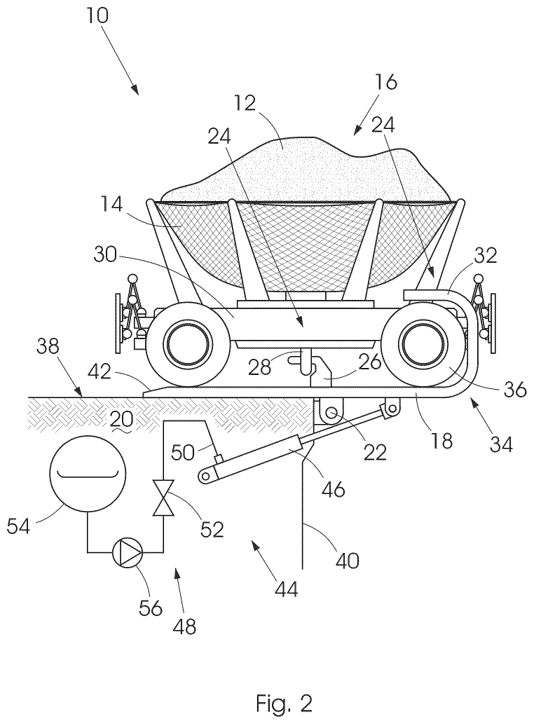

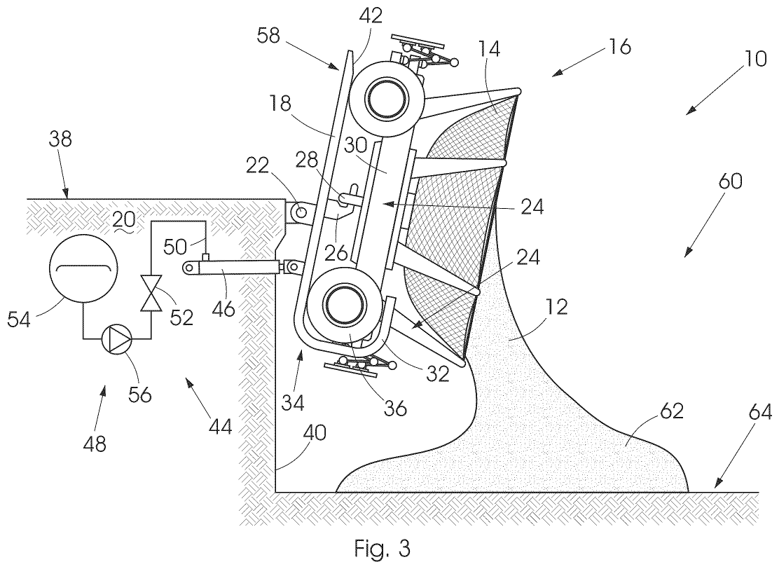

The support surface 18 is fitted to a base structure 20 of the system 10 by means of a pivot or hinge 22. The pivot 22 allows the support surface 18 to pivot or articulate relative to the base structure 20. More particularly, the support surface 18 is pivotable between a first position (shown in FIGS. 1 and 2) in which the support surface 18 is substantially horizontal and a second position (shown in FIG. 3) in which the support surface 18 is in a substantially vertical orientation. The first and second positions may, in this example, represent extremities of a permissible range of motion or pivoting of the support surface 18. The first position therefore represents an upper-most or raised position of the support surface 18 while the second position represents a lower-most or lowered position of the support surface 18. The first position may be a “loading” position (in the sense that the vehicle 16 may be loaded onto the support surface 18 while same is in the first position), while the second position may be a “tipped” or “unloading” position, in that the support surface 18 may be tipped forwards thereby facilitating the unloading of the load of raw material 12 from the vehicle 16.

Furthermore, the support surface 18 is specifically configured for receiving the vehicle 16 on top thereof. Again, the support surface 18 may be shaped and sized with specific dimensions of the vehicle 16 in mind and may in this way be configured to be compatible with the vehicle 16. The system 10 includes a retaining formation or arrangement (indicated generally and collectively by reference numeral 24). The retaining arrangement 24 is provided for retaining or releasably fixing the vehicle 16 to the support surface 18 in use, to allow the vehicle to pivot or articulate with the support surface 18 when same is pivoted to the second position, as discussed more fully below.

Again, the present disclosure is not intended to be limited by the specific configuration of the retaining arrangement 24, and same may take various forms not detailed herein.

That said, in the example embodiment shown in the figures the retaining formation 24 comprises two subcomponents or arrangements.

The first of these comprises a hook formation 26 which is configured to latch or catch onto a catch formation 28 situated towards a bottom portion of a chassis 30 of the vehicle 16. The hook formation 26 faces or points in a direction from which the vehicle 16 approaches the support surface 18, allowing the hook formation 26 to slide into engagement with the catch formation 28 as the vehicle 16 moves into position on the support surface 18. It will be appreciated that the hook formation 26 and catch formation 28 may have inherent (and/or automated) adjustability capabilities to enable accurate and secure engagement. Furthermore, the hook formation 26 may lock into an engaged configuration during use. Also, it is conceivable for the hook formation 26 to be fitted to the chassis 30 of the vehicle 16 while the catch formation 28 is fitted to the support surface 18.

The second subcomponent of the retaining formation 24 comprises a receiving formation or structure 32 which is typically formed towards a front end 34 of the support surface 18. The receiving structure 32 also catches onto the vehicle 16 and aids to secure same relative to the support surface. In the illustrated example, the receiving structure 32 catches onto a first set of wheels 36 of the vehicle 16. It will be appreciated, though, that the receiving structure 32 may catch onto other suitable parts of the vehicle, such as the chassis, a purpose-provided hook formation, or the like.

Collectively, the retaining formation 24 therefore retains the vehicle 16 securely to the support surface 18. Particularly, the retaining formation 24 inhibits the vehicle 16 from being displaced in a forwards or upwards direction relative to the support surface 18 (“forwards” and “upwards” here are described relative to the support surface irrespective of the orientation or position of the support surface 18). Both forwards and upwards displacement need to be inhibited, because of the forwards articulation of the support surface (and vehicle 16).

The configuration of the system 10 is such that the support surface 18 is pivoted or tipped in a travel direction of the vehicle 16. This is significant, since no unusual forces or stresses (such as lateral forces or stresses) are transferred to the wheels, tires or chassis during use of the system. The vehicle 16 may therefore simply move onto the support surface 18 in a travel direction, become retained relative to the support surface 18, and may then be tipped in the same direction when the support surface 18 pivots forwards towards the second position. This means that stresses and forces transmitted to the vehicle 16 are in-line with stresses and forces which the vehicle 16 is typically designed to withstand, and as a generalised rule, no specific provision needs to be made from a design point of view to enable the vehicle to withstand these forces and stresses.

Typically, the base structure 20 has a first level or surface 38 on which the vehicle 16 is supported before being loaded or received onto the support surface 18. The support surface 18 is substantially on the same level as the first level 38, such that the support surface 18 is accessible to the vehicle from the first level 38. The support surface 18 may include ramped portions 42 to facilitate such loading of the vehicle 16 onto the support surface 18. Alternatively (not shown), the support surface 18 may be received in sunken portions of the first surface 38. The pivot 22 is fixed relative to an edge 40 of the base structure 20.

A first locking arrangement (not shown in the figures) is provided for locking the support surface 18 in the first position, and a second locking arrangement may be provided for locking the support surface 18 in the second position. These locking arrangements may take various forms, such as for example, physical mechanical locks provided to interact with the support surface 18. In an alternative example (as discussed more fully below), the locking arrangement may take the form of a specific configuration of a hydraulic circuit associated with the system 10. Irrespective of the embodiment taken by the locking arrangement, the support surface 18 needs to be lockable in the first position to ensure that same doesn't start tipping under the weight of the vehicle 16 (or even of the support surface 18 itself) towards the second position, while the vehicle 16 is in the process of being loaded onto the support surface 18, and therefore before the vehicle 16 is properly retained in position. It will be appreciated that the support surface 18 is arranged such that same will be out of balance when the vehicle 16 is loaded thereon and will therefore naturally tip forwards towards the second position, unless locked in position. Once the vehicle 16 is retained in position, the first locking arrangement may be released, allowing the support surface 18 to pivot forwards under gravity. In some cases, the second locking arrangement may be omitted. However, as discussed further below, in some cases the support surface is biased towards the first position, which requires of the support surface 18 to be lockable in the second position, to facilitate unloading of the vehicle 16 without the support surface 18 pivoting back towards the first position.

The system 10 includes an energy harnessing arrangement (indicated generally by reference numeral 44). Again, the energy harnessing arrangement may take various forms, only one of which is shown in the figures, and only some of which are discussed herein. The invention may therefore extend to other forms of energy harnessing arrangement not shown or discussed. The energy harnessing arrangement 44 is configured to harness and store energy while the support surface 18 pivots under load (in other words, while the vehicle 16 is retained in position) towards the second position. As discussed more fully below, the energy harnessed and stored in this way may at a later stage be utilised, to pivot the support surface 18 back to the first position after the load of raw material 12 has been unloaded from the vehicle. In some cases, an amount of energy harnessed may be sufficient to return the support surface 18 and vehicle 16 to the first position without the need for externally provided sources of energy. This may theoretically be possible, since after unloading, the total weight (of the support surface 18 and vehicle 16 combined) that needs to be returned to the first position is much lower than the total weight before unloading, which was available and used when harnessing the energy.

In the example shown in the figures, the system 10 includes an actuator in the form of a hydraulic ram 46 (piston and cylinder arrangement) which forms part of the energy harnessing system 44. The hydraulic ram 46 is also used to return the support surface 18 to the first position. The system 10 also includes a hydraulic circuit 48, which includes hydraulic fluid lines 50, flow controllers (shown schematically and in simplified form by a valve and reference numeral 52) and a hydraulic accumulator 54.

Even though the flow controllers 52 are shown as a simplified valve, it will be appreciated that a variety of controllers, including shut-off valves, directional flow control valves, fluid lines provided in parallel, and the like may be included, and that various fluid-flow paths may be created by configuring the various flow controllers in a number of ways.

For example, the hydraulic circuit 48 may be configured in a first configuration where fluid flow to and/or from the hydraulic ram 46 is inhibited. This may be achieved by closing a valve in communication with an entry to the hydraulic ram 46. Inhibiting fluid flow to or from the hydraulic ram 46 results in locking the ram in a predetermined position. Therefore, configuring the system 10 in this way may be used to lock the support surface 18 in the first and second positions, as discussed above (and therefore, in this case, physical mechanical locks interacting directly with the support surface 18 are not required to perform the locking function). It will be appreciated that the above may also be achieved by providing a one-way valve in the hydraulic circuit 48 which allows flow from, for example the hydraulic ram 46, but not back towards the hydraulic ram 46.

The hydraulic circuit 48 may be configured in a second configuration wherein hydraulic fluid is allowed to flow from the hydraulic ram 46 towards the hydraulic accumulator 54. The hydraulic circuit 48 is configured in this way to allow the support surface 18 to pivot from the first position towards the second position.

By regulating the rate of fluid flow through the hydraulic circuit 48 when configured in this way, the rate at which the support surface 18 pivots forwards may be controlled and damped. Furthermore, because of the weight of the support surface 18 and (loaded) vehicle 16 bearing down on the hydraulic ram 46, hydraulic fluid in the hydraulic circuit 48 is pressurised, and the hydraulic accumulator 54 may therefore be charged with pressurised hydraulic fluid. The pressurised hydraulic fluid stored within the hydraulic accumulator 54 represents harnessed and stored potential energy.

Even though, theoretically, the energy stored in the hydraulic accumulator 54 may be utilised to drive external equipment, same is instead, typically, used to provide a source of energy used to return the support surface 18 and vehicle 16 to the first position. The energy, or any surplus energy available after the support surface has been returned to the first position, may be provided to external equipment, an electricity grid, or the like. The system may include equipment for converting the potential energy into a form usable by the external equipment or circuit (such as into electricity).

For the purpose of returning the support surface and vehicle to the first position, the hydraulic circuit 48 is configurable in a third configuration, in which hydraulic fluid is allowed to flow from the hydraulic accumulator 54 towards the hydraulic ram 46. Pressurised fluid flowing from the hydraulic accumulator 54 towards the hydraulic ram 46 may actuate the hydraulic ram 46 causing same to exert an upward tilting force on the support surface 18. As discussed above, in some cases, the force so exerted on the support surface 18 may be sufficient to pivot the support surface 18 and vehicle 16 back to the first position, allowing the unloaded vehicle 16 to be removed from the support surface 18. In some cases, the force provided by the hydraulic ram 46 on the support surface 18 may need to be supplemented to be sufficient to pivot the support surface 18 back to the first position. A hydraulic pump 56 may be provided as part of the hydraulic circuit 48, for this purpose. In the latter case, the energy provided by the hydraulic accumulator 54 represents a reduction in the amount of external energy required to lift the support surface 18 and vehicle 16 back to the first position.

In some cases, the support surface 18 may be biased towards the first position. This may, for example, be the case in the above example of the energy harnessing arrangement 44 and may be provided to reduce the load that has to be lifted back towards the first position. However, it will be appreciated that a balance needs to be struck between the extent to which the support surface 18 may be biased towards the first position and the speed at which the support surface 18 will pivot towards the second position under the load of the loaded vehicle 16 and/or the amount of energy that may be harnessed while so pivoting towards the second position.

In other cases, the biasing of the support surface 18 towards the first position may represent an embodiment of the energy harnessing arrangement itself. This is not shown. However, in this case, the biasing of the support surface towards the first position is carefully configured to ensure that the load of the vehicle 16 when fully loaded is enough to overcome the bias of the support surface 18 and therefore pivot same towards the second position, but also configured to ensure that the bias is sufficient to cause the support surface 18 and unloaded vehicle 16 to be pivoted back to the first position. In this case, the rate at which the vehicle 16 is unloaded (and therefore, the rate at which a load exerted on the support surface 18 against the bias decreases) needs to be considered, to ensure that the support surface 18 does not start pivoting back towards the second position before proper unloading of the vehicle 16. This can be achieved by selecting and configuring the bias correctly but may furthermore be facilitated by the second locking arrangement discussed before. In such an example, a hydraulic circuit may be provided, not for the purpose of harnessing energy, but simply to act as a locking arrangement. A hydraulic ram 46 may again be provided, and a one-way valve may allow fluid to flow from the hydraulic ram 46 and not back towards the hydraulic ram 46, thereby inhibiting the support surface 18 from pivoting back towards the first position as the load exerted on the support surface 18 lessens. Once fully unloaded, the hydraulic ram may be released (such as by opening a bypass valve in a parallel circuit), allowing the support surface 18 to start pivoting back to the first position under the bias. The biasing of the support surface 18 towards the first position may be achieved in a number of ways, such as by fitting a counterweight directly to a loading side 58 of the support surface 18, or by providing a counterweight connected to the support surface 18 by means of a pulley system. Energy is therefore harnessed when the counterweight is lifted.

Typically, the base structure 20 is located proximate a dump location 60 for raw material, such that material 12 unloaded from the vehicle 16 may be dumped onto a stockpile 62 of raw material, or directly to an ore crusher and the like. Typically, the dump location 60 and or stockpile 62 is located at a second level 64 which is below the first level 38.

In some cases, which are not shown, the base structure 20 may be mobile and may be displaceable on a worksite and relative to the stockpile 62. This may be especially useful when the system 10 is used for raw material handling on a construction site or a waste dump site. In such a case, the mobile base may therefore be adaptable to enable dumping of material in line or parallel, perpendicular, or at an oblique angle to a window through which material can be received.

During use, the vehicle 16 is therefore driven onto the support surface 18, which is locked in the first position, and retained relative to the support surface using the retaining arrangement 24. Next, the support surface 18 is released from the first position and pivoted towards the second position, where again, the support surface 18 is locked in position. The support surface 18 is retained in the second position for a sufficient amount of time to facilitate unloading of the raw material 12 from the carrier body 14 and onto the stockpile 62 (or a receiving chute or window). The support surface may now be released from the second position and returned and retained in the first position. The retaining formation 24 may now be released and the vehicle may be driven off the support surface 18. This represents a single unloading cycle of the system 10.

It will be appreciated that the cycle and the layout of the system 10 lends itself to a degree of automation.

Furthermore, it is believed that the use of the system 10 would facilitate the use of vehicles 16 without on-board hardware required for unloading of the raw material 12. This, in turn, results in vehicles 16 with a lower tare weight, in turn, reducing energy expenditure associated with raw material handling.

Also, providing an energy harnessing arrangement 44 eliminates, or at least reduces the amount of external energy that needs to be provided to facilitate the unloading of the vehicle 16. It is therefore believed that the use of the system 10 could result in an overall reduction in energy required during raw material handling processes of mining and/or construction operations. It will be appreciated that the above description only provides some example embodiments of the invention and that there may be many variations without departing from the spirit and/or the scope of the invention.

For example, provision is made for the support surface 18 to be configured in a side-tipping configuration (whilst still including an energy harnessing arrangement). Therefore, even when the vehicle is not necessarily pivoted in a forwards or travel direction, at least some of the aforementioned benefits may be realised.

Furthermore, the hydraulic ram 46 (and all the related hydraulic equipment) may be replaced by purely mechanical, or electromechanical equipment. For example, the actuator may instead comprise a linear actuator driven by an electric motor. Energy may therefore be harnessed when the support surface is pivoted to the second position under load, by driving an alternator/generator, and electricity generated during this process may be stored in a battery or capacitor, or directly provided to a grid or external system. Further alternatively, during the energy harnessing cycle, a linear displacement of the linear actuator may be translated to rotation, in turn driving a flywheel to store potential energy for later use.

Even further alternative configurations are also possible, for example, in cases where a linear actuator is used, and during the harvesting cycle, a hydraulic pump/motor unit may be driven and used to charge an accumulator in similar fashion as previously discussed. Further undisclosed forms of actuation and/or energy harvesting may also be possible.

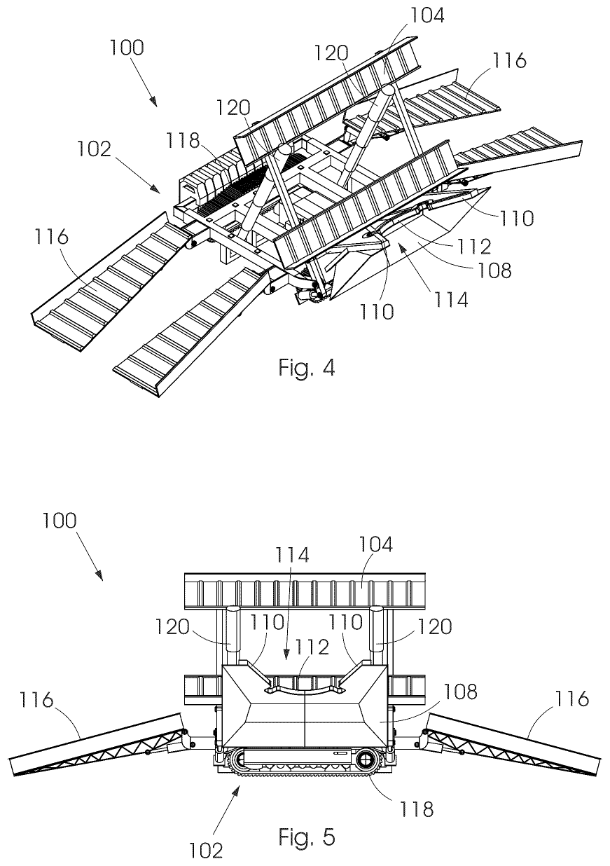

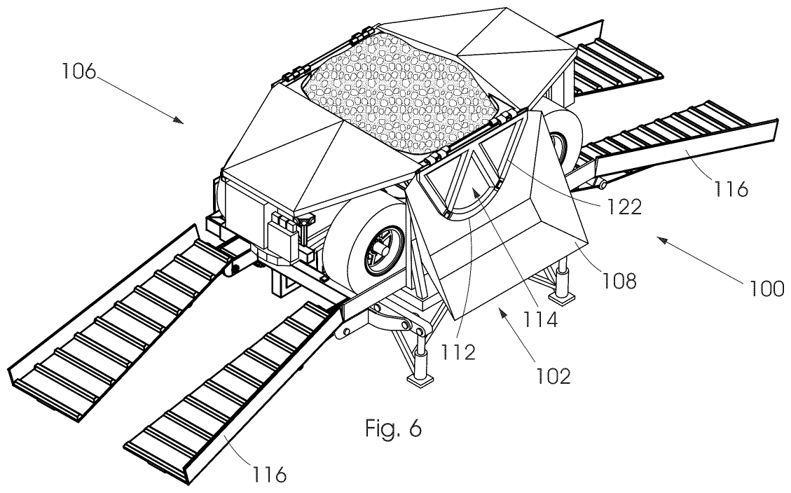

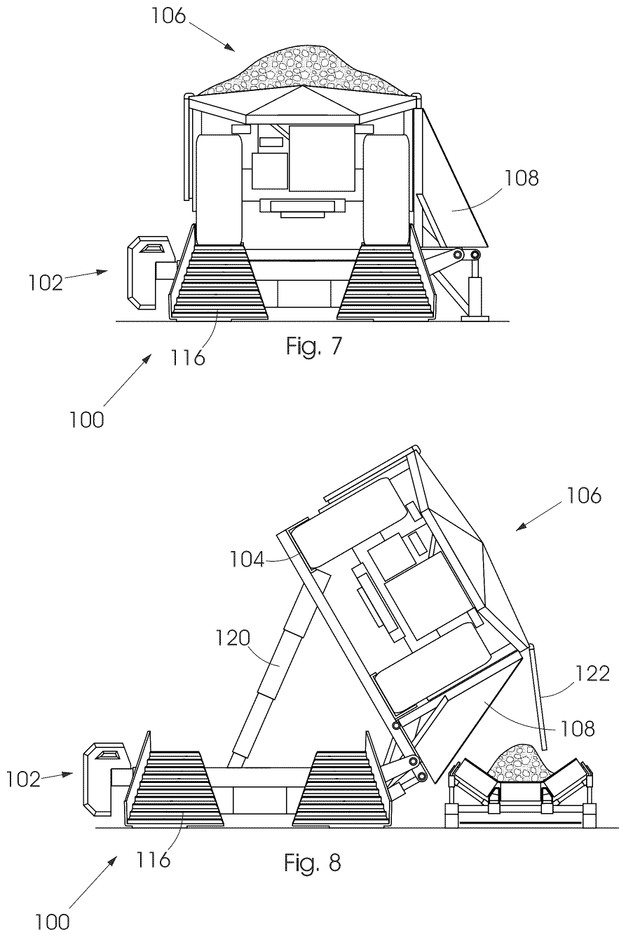

An alternative unloading system for a haul vehicle 106 is shown in FIGS. 4 to 8 and generally indicated by reference numeral 100. The unloading system 100 as illustrated is configured in a side-tipping configuration and associated with a mobile base structure 102 which includes ramps 116 from a ground surface on which the base structure 102 is supported. The mobile base structure 102 may include tracks 118 (as shown) or wheels. It will be appreciated that the unloading system 100 may, in examples not shown or further discussed herein, be configured as a front-tipping unloading system, and the base structure may be replaced by a stationary base structure. Combinations of the aforementioned variations may be possible. Furthermore, it will be appreciated from the figures that the unloading system 100 as shown does not include an energy harnessing arrangement, even though provision is made for examples including such energy harnessing arrangements, in which case the system 100 may result in the same advantages as discussed before and relating to the energy harnessing arrangement.

The unloading system 100 includes a support surface 104, which is again pivotable relative to the base structure 102 between a first and second position.

The system 100 furthermore includes a brace unit 108 which engages a structural part of the haul vehicle 106 in use. Once engaged, the brace unit 108 and support surface 104 are fixed relative to each other. The configuration of the brace unit 108 is such that it supports the haul vehicle 106 when the support surface 104 is pivoted to the second position, and therefore retains the haul vehicle 106 relative to the support surface 104.

In some cases, the brace unit 108 is permanently fixed relative to the support surface 104, and the haul vehicle 106 may therefore simply drive onto the support surface 104 until contact is made with the brace unit 108. This may typically be the case when the system 100 is configured as a front-tipping system.

In other cases, such as when the system 100 is configured as a side-tipping system, the brace is displaceable relative to the support surface 104 between a disengaged configuration and an engaged configuration. The brace unit 108 may typically be fitted relative to the support surface in pivotable fashion for this purpose. The brace unit 108 is provided in the disengaged configuration when the haul vehicle 106 is propelled onto the support surface, to provide a spacing between the brace unit 108 and the haul vehicle 106. Once the haul vehicle 106 is in position, the brace unit 108 is displaced towards and locked in the engaged configuration, in which contact is made with the structural part of the haul vehicle.

The brace unit 108 comprises one or more contact shoes 110 with which a distributed load is exerted on the structural part of the haul vehicle 106.

The brace unit 108 has a rim portion 112 with a shape similar to that of the structural part of the haul vehicle 106. The contact shoes 110 may extend along the rim portion. In the example shown in the figures (and particularly in the case of side-tipping configurations) the rim portion 112 is substantially U-shaped such that an opening 114 is defined through which material is unloaded from the haul vehicle 106. The opening 114 has a shape similar to an unloading door of the haul vehicle 106.

The system 100 also includes a lifting or pivoting mechanism 120 with which the support surface 104 is pivoted between the first and second positions. This pivoting mechanism 120 typically takes the form of a hydraulic ram arrangement.

In use, the haul vehicle 106 is propelled onto the support surface 104 and is parked in a predetermined position. The brace unit 108 is brought into contact with the structural part of the haul vehicle 106. The support surface 104 is now pivoted towards the second position, allowing the weight of the haul vehicle to be supported, at least in part, by the brace unit 108. A door 122 of the haul vehicle 108 is unlatched, allowing same to open and allowing the load of the haul vehicle 106 to be unloaded through the open door 122 and opening 114 of the brace unit 108. Once unloaded, the support platform is pivoted back to the first position, the brace unit 108 is configured towards the disengaged configuration, and the haul vehicle 106 is allowed to drive off the support platform 104.

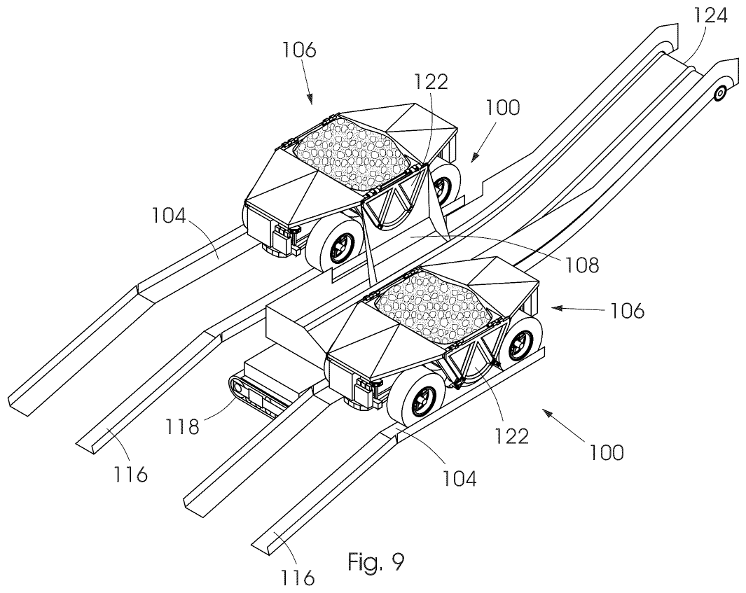

It is believed that by using the brace unit 108 to support the weight of the haul vehicle (or at least a portion thereof) during unloading, loads which are typically exerted on the wheels and chassis of the haul vehicle (when using conventional tipping unloading systems) may be reduced. In some cases, as shown in FIG. 9 more than one unloading system 100 may be arranged in side-by-side fashion, and the two unloading systems may be configured to unload their respective haul vehicles onto a single, shared pile, into a single chute or onto a conveyor 124. In such cases, the unloading systems are therefore configured to tip in opposite directions.

It will easily be understood from the present disclosure that the particular features of the present invention, as generally described and illustrated in the figures, can be arranged and designed according to a wide variety of different configurations. In this way, the description of the present invention and the related figures are not provided to limit the scope of the invention but simply represent selected embodiments.

The skilled person will understand that the technical characteristics of a given embodiment can in fact be combined with characteristics of another embodiment, unless otherwise expressed or it is evident that these characteristics are incompatible. Also, the technical characteristics described in a given embodiment can be isolated from the other characteristics of this embodiment unless otherwise expressed.

1-38. (canceled)

39. An unloading system for a haul vehicle, the system comprising:
a support surface configured for operatively receiving the vehicle, which support surface is fixed to a base structure and pivotable between a first position which is a loading position in which the support surface is configured in a substantially horizontal orientation to allow loading the vehicle onto the support surface and a second position which is a tipped position;
a retaining arrangement for operatively releasably retaining the vehicle relative to the support surface;
an energy harnessing arrangement, configured to harness energy when the support surface is pivoted under load to the second position.

40. The unloading system according to claim 39, wherein the second position is a tipped position in which the support surface is tipped in a travel direction of the vehicle.

41. The unloading system according to claim 39, wherein the base structure comprises a first level, and wherein the support surface is fitted to the base structure by means of a pivot and to be accessible from the first level by the vehicle when the support surface is in the first position, wherein the system is arranged proximate a raw material dump location which is situated at a level below the first level.

42. The unloading system according to claim 41, wherein the base structure is a mobile base which includes means in the form of one of wheels and tracks for displacing the base relative to a ground surface and wherein the unloading system further includes a ramp from the ground surface to the first level, allowing the haul vehicle to be propelled onto the support surface.

43. The unloading system according to claim 39, wherein the retaining arrangement includes one of:
i) a hook formation for operatively latching onto a catch formation associated with the vehicle;
ii) a catch formation for operatively latching onto a hook formation associated with the vehicle; and
iii) a receiving formation for operatively receiving a first set of wheels of the vehicle and retaining same relative to the support surface

44. The unloading system according to claim 39, further comprising an actuator in the form of a hydraulic ram operatively to return the support surface to the first position.

45. The unloading system according to claim 44, wherein the hydraulic ram forms part of the energy harnessing arrangement, and wherein the hydraulic ram is provided in fluid flow communication with a hydraulic fluid circuit which includes an accumulator, and wherein the hydraulic fluid circuit includes a first flow controller with which the hydraulic fluid circuit is configurable in:
a first configuration in which fluid flow to or from the hydraulic ram is inhibited to lock the support surface in the first or second positions;
a second configuration in which flow of hydraulic fluid from the hydraulic ram into the accumulator is facilitated, thereby allowing the accumulator to be charged with pressurised hydraulic fluid thereby harnessing potential energy; and
a third configuration in which flow of hydraulic fluid from the accumulator to the hydraulic ram is facilitated, thereby allowing the hydraulic ram to actuate the support surface towards the first position.

46. The unloading system according to claim 45, wherein the hydraulic circuit includes a pump to provide pressurised hydraulic fluid to the hydraulic ram, to supplement hydraulic fluid provided to the hydraulic ram by the accumulator.

47. The unloading system according to claim 39, wherein the support surface is biased towards the first position, wherein the system is configured such that a predetermined load received on the support surface is required to overcome the bias, allowing the support surface to pivot towards the second position, wherein the configuration is such that the vehicle, when loaded, exceeds the predetermined load, and wherein the unloading system further includes a first locking arrangement provided for releasably locking the support surface in the first position, to facilitate loading the vehicle onto the support surface without it moving to the second position and a second locking arrangement provided for releasably locking the support surface in the second position.

48. The unloading system according to claim 47, wherein the support surface is associated with a counterweight which biases same towards the first position, the counterweight being one of: a) fixed directly to a first side of the support surface; and b) connected to the support surface by means of a pulley system.

49. A method of unloading raw material from a haul vehicle, the method comprising the steps of:
i) providing a system according to claim 39;
ii) receiving the vehicle on a support surface of the system which is provided in a first position;
iii) releasably retaining the vehicle relative to the support surface;
iv) allowing the support surface to pivot towards a second position;
v) harnessing energy by means of an energy harnessing arrangement while the support surface pivots towards the second position.

50. The method of claim 49, comprising the further steps of:
vi) configuring a lock arrangement of the system to lock the support surface in the second position and allowing the raw material to be unloaded from the haul vehicle;
vii) configuring the lock arrangement to allow the support surface to be displaced from the second position and utilising at least some of the harnessed energy to return the support surface to the first position;
viii) releasing the vehicle from the support surface; and
ix) removing the vehicle from the support surface.

51. The method of claim 50, wherein step v) comprises configuring a hydraulic ram of the system to pump hydraulic fluid into a hydraulic accumulator and wherein step vii) comprises allowing at least some hydraulic fluid stored within the hydraulic accumulator to flow towards the hydraulic ram.

52. The method of claim 51, including supplementing fluid flowing towards the hydraulic ram utilising a hydraulic pump.

53. The method according to claim 49, wherein:
step ii) is preceded by a sub-step of configuring a lock arrangement of the system to lock the support surface in the first position;
step iv) is preceded by the sub-step of configuring the lock arrangement to allow the support surface to be displaced from the first position; and
step iv) comprises allowing the support surface to pivot towards the second position under a load caused by the vehicle being received on the support surface.

54. An unloading system for a haul vehicle, the system comprising:
a support surface configured for operatively receiving the vehicle, which support surface is fixed to a base structure and pivotable between a first position and a second position;
a brace unit configured for operatively engaging a structural part of the vehicle thereby supporting and/or retaining the vehicle relative to the support surface when the support surface is pivoted to the second position; and
a pivoting mechanism for pivoting the support surface between the first position and second position.

55. The unloading system according to claim 54, wherein the brace unit is configurable between a disengaged configuration in which the brace unit is operatively spaced from a structural part of the haul vehicle, and an engaged configuration, in which the brace unit operatively engages the structural part of the haul vehicle, and wherein the brace unit lockable in the engaged configuration.

56. The unloading system according to claim 54, wherein the brace unit comprises at least one of:
one or more contact shoes provided for operatively exerting a distributed load on the
a rim portion which is shaped commensurate with the structural part of the haul vehicle and wherein the rim portion defines an opening through which material is operatively unloaded from the haul vehicle.

57. The unloading system according to claim 56, wherein the opening is substantially U-shaped.

58. The unloading system according to claim 54, wherein the base structure is a mobile base which includes means in the form of one of wheels and tracks for displacing the base relative to a ground or support surface, and wherein the unloading system further includes a ramp from the ground surface to the support surface, allowing the haul vehicle to be propelled onto the support surface.
